(19) United States
(12) Patent Application Publication
(10) Pub. No.: US 2017/0017373 A1
(43) Pub. Date: Jan. 19, 2017

(54) ELECTRONIC DEVICE AND METHOD FOR CONTROLLING THE SAME

(71) Applicant: Samsung Electronics Co., Ltd., Suwon-si (KR)

(72) Inventors: Soe-Youn YIM, Seoul (KR); Ju-Yeoung KIM, Gunpo-si (KR); Sae-Gee OH, Goyang-si (KR); Sang-Yoon LEE, Seoul (KR); Sung-Jin KIM, Seoul (KR); Jung-Bum HUR, Seongnam-si (KR)

(21) Appl. No.: 15/211,392

(22) Filed: Jul. 15, 2016

Related U.S. Application Data
(60) Provisional application No. 62/192,742, filed on Jul. 15, 2015.

(30) Foreign Application Priority Data
May 18, 2016 (KR) 10-2016-0060826

(51) Int. Cl. G06F 3/0481; G06F 3/01; G06F 3/0484; G06F 3/16

(52) U.S. Cl. CPC G06F 3/04812; G06F 3/167; G06F 3/017; G06F 3/04842

(57) ABSTRACT

An electronic device is provided. The electronic device includes a display configured to display at least one object, a sensor configured to detect a gesture, and a processor configured to move a pointer from a first position to a second position on the display, corresponding to a moving distance of the gesture, and when the pointer meets a certain condition, move the pointer to a third position on the display.

### CROSS-REFERENCE TO RELATED APPLICATION(S)

This application claims the benefit under 35 U.S.C. §119(e) of a U.S. provisional application filed on Jul. 15, 2015 in the U.S. Patent and Trademark Office and assigned Ser. No. 62/192,742, and under 35 U.S.C. §119(a) of a Korean patent application filed on May 18, 2016 in the Korean Intellectual Property Office and assigned Serial number 10-2016-0060826, the entire disclosure of each of which is hereby incorporated by reference.

### TECHNICAL FIELD

The present disclosure relates to electronic devices, e.g., electronic devices allowing for easier selection of a button on the screen and methods for controlling the same.

### BACKGROUND

Disclosed is a technique of the related art in which tile-shaped buttons are arrayed at narrow intervals on, e.g., a television (TV) interface so that a hand pointer is moved thereon by way of a remote controller, and if positioned on a button, the button is outlined in white to indicate the position of the button, and when the hand pointer stays thereon for a certain time or longer, it's corresponding function runs.

TV of the related art interfaces display buttons in a larger size or in a line on a central area of the display to overcome the limited features of motion detection.

Such scheme of the related art as to move a hand to select a button and let the hand stay on the button for a certain time to run the function corresponding to the button puts children who cannot do delicate hand manipulation in less availability and more difficulty.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device having a motion interaction technology optimized for children allowing them to select a button and run its corresponding function in an easier and more fun manner through a television (TV) interface rather than a motion detection interface or user experience (UX) scheme as proposed for adults according to the related art.

In accordance with an aspect of the present disclosure, an electronic device is provided. The electronic device includes a display configured to display at least one object, a sensor configured to detect a gesture, and a processor configured to move a pointer from a first position to a second position on the display, corresponding to a moving distance of the gesture, and when the pointer meets a certain condition, move the pointer to a third position on the display.

In accordance with another aspect of the present disclosure, a method for controlling an electronic device is provided. The method includes displaying at least one object, detecting a gesture, moving a pointer from a first position to a second position corresponding to a moving distance of the gesture, and moving the pointer to a third position when the pointer meets a certain condition.

According to various embodiments of the present disclosure, the electronic device may provide a motion detection UX easier to use and optimized for children (e.g., ages three to seven) who have less delicacy in manipulation, attention, and understanding than adults.

Further, there are provided an animation or page objects (buttons) immediately responsive to children's motion or movement, leading them to be more engaged.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a use environment of a plurality of electronic devices according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIG. 4 is a flowchart illustrating a method for controlling an electronic device according to an embodiment of the present disclosure;

FIG. 5 illustrates a structure of a motion detection user experience (UX) screen according to an embodiment of the present disclosure;

FIG. 6 illustrates an app page screen according to an embodiment of the present disclosure;

FIG. 7 illustrates an app page screen according to an embodiment of the present disclosure;

FIGS. 8A and 8B illustrate a first object according to an embodiment of the present disclosure;

FIG. 9 illustrates an app page screen according to an embodiment of the present disclosure;

FIGS. 10A and 10B illustrate a method for moving a pointer according to an embodiment of the present disclosure;

FIG. 11 illustrates an app page screen according to an embodiment of the present disclosure;

FIG. 12 illustrates an app page screen according to an embodiment of the present disclosure;

FIG. 13 illustrates an app page screen according to an embodiment of the present disclosure;

FIG. 14 illustrates an app page according to an embodiment of the present disclosure;

FIG. 15 illustrates an app page according to an embodiment of the present disclosure;

FIG. 16 illustrates an app page according to an embodiment of the present disclosure;

FIG. 17 illustrates an app page according to an embodiment of the present disclosure;

FIG. 18 illustrates an app page according to an embodiment of the present disclosure;

FIG. 19 illustrates an app page according to an embodiment of the present disclosure;

FIG. 20 illustrates a first object and a second object according to an embodiment of the present disclosure;

FIGS. 21 and 22 illustrate app pages according to various embodiments of the present disclosure; and

FIG. 23 illustrates an app page according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

For example, examples of the electronic device according to various embodiments of the present disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), a moving picture experts group phase 1 or phase 2 (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments of the present disclosure, examples of the smart home appliance may include at least one of a television (TV), a digital video disc (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs) of financial organizations, point of sales (POS) devices of stores, or Internet of things devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves). According to various embodiments of the present disclosure, the electronic device may be flexible or may be a combination of the above-enumerated electronic devices. According to an embodiment of the present disclosure, the electronic device is not limited to the above-listed various embodiments. As used herein, the term “user” may denote a human or another device (e.g., an artificial intelligent electronic device) using the electronic device.

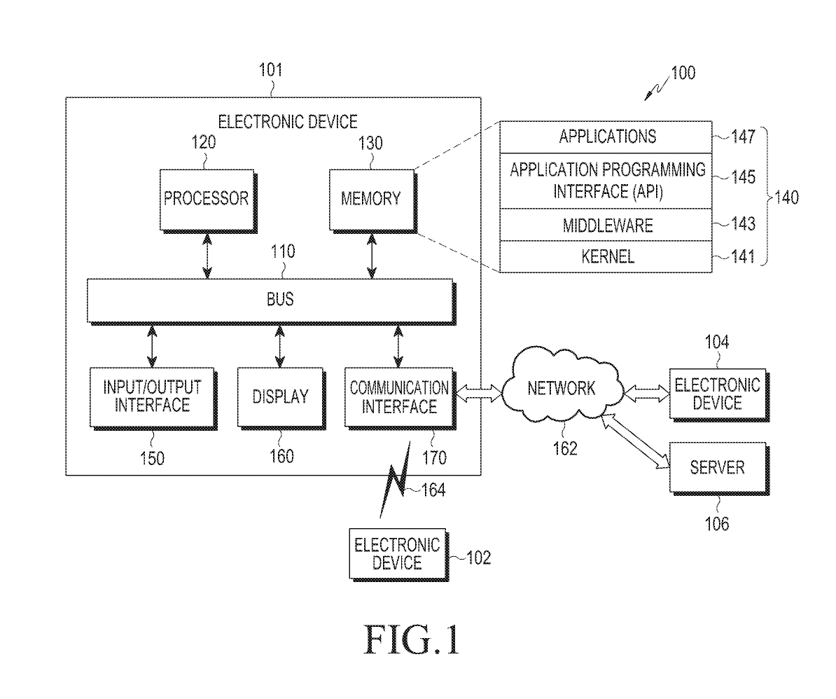

FIG. 1 is a view illustrating a use environment of a plurality of electronic devices according to an embodiment of the present disclosure.

Referring to FIG. 1, according to an embodiment of the present disclosure, an electronic device 101 is included in a network environment 100. The electronic device 101 may include a bus 110, a processor 120, a memory 130, an input/output interface 150, a display 160, and a communication interface 170. In some embodiments of the present disclosure, the electronic device 101 may exclude at least one of the components or may add another component. The bus 110 may include a circuit for connecting the components 110 to 170 with one another and transferring communications (e.g., control messages or data) between the components. The processing module 120 may include one or more of a CPU, an AP, or a communication processor (CP). The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS). For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. Further, the middleware 143 may process one or more task requests received from the application program 147 in order of priority. For example, the middleware 143 may assign a priority of using system resources (e.g., bus 110, processor 120, or memory 130) of the electronic device 101 to at least one of the application programs 147 and process one or more task requests. The API 145 is an interface allowing the application 147 to control functions provided from the kernel 141 or the middleware 143. For example, the API 133 may include at least one interface or function (e.g., a command) for filing control, window control, image processing or text control. For example, the input/output interface 150 may transfer commands or data input from the user or other external device to other component(s) of the electronic device 101 or may output commands or data received from other component(s) of the electronic device 101 to the user or other external devices.

The display 160 may include, e.g., a liquid crystal display (LCD), a light emitting diode (LED) display, an organic LED (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user. For example, the communication interface 170 may set up communication between the electronic device 101 and an external electronic device (e.g., a first electronic device 102, a second electronic device 104, or a server 106). For example, the communication interface 170 may be connected with a network 162 through a wireless communication 164 or a wired communication to communicate with the external electronic device (e.g., the second external electronic device 104 or server 106).

The wireless communication may include cellular communication using at least one of, e.g., long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). According to an embodiment of the present disclosure, the wireless communication may include at least one of, e.g., Wi-Fi, Bluetooth (BT), BT low power (BLE), Zigbee, near field communication (NFC), magnetic secure transmission (MST), radio frequency (RF), or body area network (BAN). According to an embodiment of the present disclosure, the wireless communication may include GNSS. The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The first and second external electronic devices 102 and 104 each may be a device of the same or a different type from the electronic device 101. According to an embodiment of the present disclosure, all or some of operations executed on the electronic device 101 may be executed on another or multiple other electronic devices (e.g., the electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

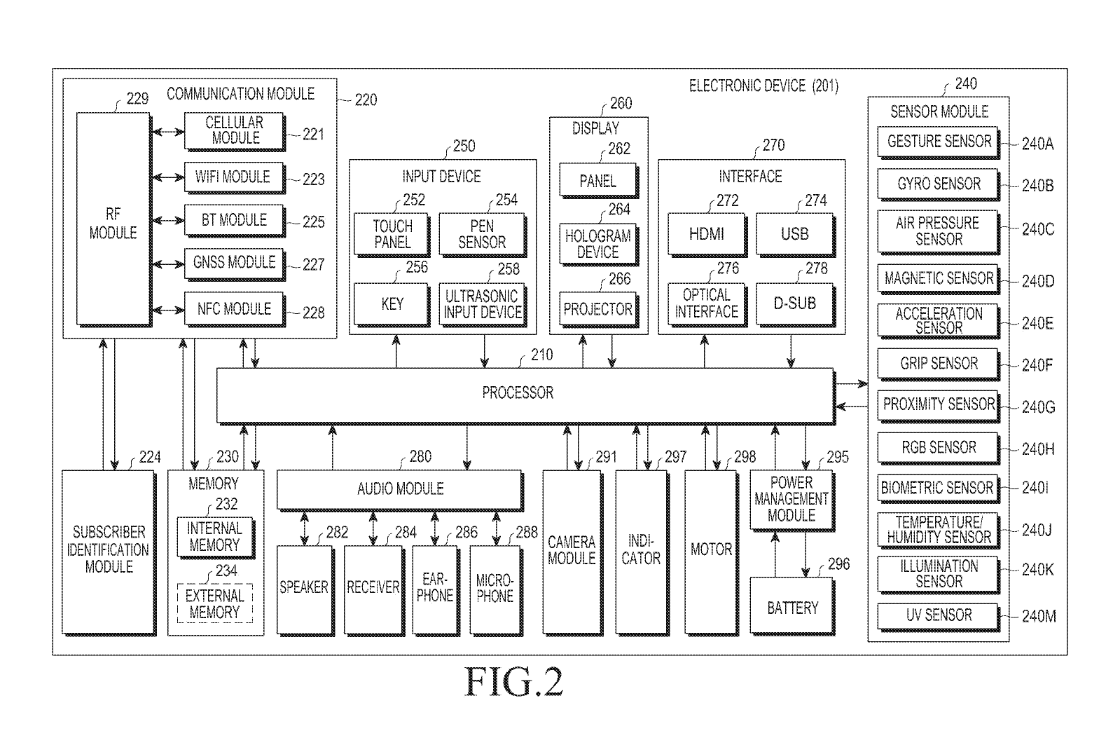

FIG. 2 is a block diagram illustrating an electronic device according to an embodiment of the present disclosure.

Referring to FIG. 2, an electronic device 201 may include the whole or part of the configuration of, e.g., the electronic device 101 shown in FIG. 1.

The electronic device 201 may include one or more processors (e.g., APs) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control multiple hardware and software components connected to the processor 210 by running, e.g., an OS or application programs, and the processor 210 may process and compute various data. The processor 210 may be implemented in, e.g., a system on chip (SoC). According to an embodiment of the present disclosure, the processor 210 may further include a graphics processing unit (GPU) and/or an image signal processor (ISP). The processor 210 may include at least some (e.g., the cellular module 221) of the components shown in FIG. 2. The processor 210 may load a command or data received from at least one of other components (e.g., a non-volatile memory) on a volatile memory, process the command or data, and store resultant data in the non-volatile memory.

The communication module 220 may have the same or similar configuration to the communication interface (e.g., the communication interface 170) of FIG. 1. The communication module 220 may include, e.g., a cellular module 221, a Wi-Fi module 223, a BT module 225, a GNSS module 227, a NFC module 228, and a RF module 229. The cellular module 221 may provide voice call, video call, text, or Internet services through, e.g., a communication network. The cellular module 221 may perform identification or authentication on the electronic device 201 in the communication network using a SIM 224 (e.g., the SIM card). According to an embodiment of the present disclosure, the cellular module 221 may perform at least some of the functions providable by the processor 210. According to an embodiment of the present disclosure, the cellular module 221 may include a CP. According to an embodiment of the present disclosure, at least some (e.g., two or more) of the cellular module 221, the Wi-Fi module 223, the BT module 225, the GNSS module 227, or the NFC module 228 may be included in a single integrated circuit (IC) or an IC package. The RF module 229 may communicate data, e.g., communication signals (e.g., RF signals). The RF module 229 may include, e.g., a transceiver, a power amplifier module (PAM), a frequency filter, a low noise amplifier (LNA), or an antenna. According to an embodiment of the present disclosure, at least one of the cellular module 221, the Wi-Fi module 223, the BT module 225, the GNSS module 227, or the NFC module 228 may communicate RF signals through a separate RF module. The subscription identification module 224 may include, e.g., a card including a SIM or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic random access memory (DRAM), a static RAM (SRAM), a synchronous dynamic RAM (SDRAM), and the like) or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 234 may include a flash drive, e.g., a compact flash (CF) memory, a secure digital (SD) memory, a micro-SD memory, a min-SD memory, an extreme digital (xD) memory, a multi-media card (MMC), or a memory stick™. The external memory 234 may be functionally or physically connected with the electronic device 201 via various interfaces.

For example, the sensor module 240 may measure a physical quantity or detect an operational state of the electronic device 201, and the sensor module 240 may convert the measured or detected information into an electrical signal. The sensor module 240 may include at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red-green-blue (RGB) sensor, a bio sensor 2401, a temperature/humidity sensor 240J, an illumination sensor 240K, or an ultraviolet (UV) sensor 240M. Additionally or alternatively, the detection module 240 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the detection module. According to an embodiment of the present disclosure, the electronic device 201 may further include a processor configured to control the sensor module 240 as part of the processor 210 or separately from the processor 210, and the electronic device 2701 may control the sensor module 240 while the processor 210 is in a sleep mode.

The input unit 250 may include, e.g., a touch panel 252, a (digital) pen sensor 254, a key 256, or an ultrasonic input device 258. The touch panel 252 may use at least one of capacitive, resistive, IR, or ultrasonic methods. The touch panel 252 may further include a control circuit. The touch panel 252 may further include a tactile layer and may provide a user with a tactile reaction. The (digital) pen sensor 254 may include, e.g., a part of a touch panel or a separate sheet for recognition. The key 256 may include e.g., a physical button, optical key or key pad. The ultrasonic input device 258 may detect an ultrasonic wave generated from an input tool through a microphone (e.g., a microphone 288) to identify data corresponding to the detected ultrasonic wave.

The display 260 (e.g., the display 160) may include a panel 262, a hologram device 264, a projector 266, and/or a control circuit for controlling the same. The panel 262 may be implemented to be flexible, transparent, or wearable. The panel 262, together with the touch panel 252, may be configured in one or more modules. According to an embodiment of the present disclosure, the panel 262 may include a pressure sensor (or pose sensor) that may measure the strength of a pressure by the user's touch. The pressure sensor may be implemented in a single body with the touch panel 252 or may be implemented in one or more sensors separate from the touch panel 252. The hologram device 264 may make three dimensional (3D) images (holograms) in the air by using light interference. The projector 266 may display an image by projecting light onto a screen. The screen may be, for example, located inside or outside of the electronic device 201. The interface 270 may include e.g., an HDMI 272, a USB 274, an optical interface 276, or a D-subminiature (D-sub) 278. The interface 270 may be included in e.g., the communication interface 170 shown in FIG. 1. Additionally or alternatively, the interface 270 may include a mobile high-definition link (MHL) interface, a SD card/MMC interface, or infrared data association (IrDA) standard interface.

The audio module 280 may convert, e.g., a sound signal into an electrical signal and vice versa. At least a part of the audio module 280 may be included in e.g., the input/output interface 145 as shown in FIG. 1. The audio module 280 may process sound information input or output through e.g., a speaker 282, a receiver 284, an earphone 286, or a microphone 288. For example, the camera module 291 may be a device for capturing still images and videos, and may include, according to an embodiment of the present disclosure, one or more image sensors (e.g., front and back sensors), a lens, an ISP, or a flash, such as an LED or xenon lamp. The power manager module 295 may manage power of the electronic device 201, for example. According to an embodiment of the present disclosure, the power manager module 295 may include a power management integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal to a mechanical vibration and may generate a vibrational or haptic effect. The electronic device 201 may include a mobile TV supporting device (e.g., a GPU) that may process media data as per, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments of the present disclosure, the electronic device (e.g., the electronic device 201) may exclude some elements or include more elements, or some of the elements may be combined into a single entity that may perform the same function as by the elements before combined.

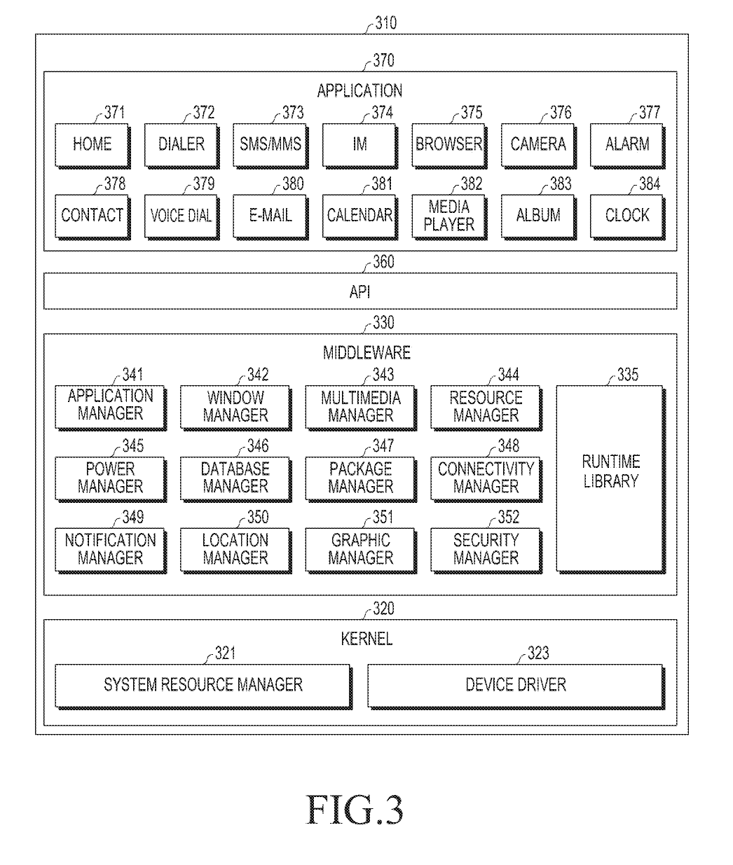

FIG. 3 is a block diagram illustrating a program module according to an embodiment of the present disclosure.

Referring to FIG. 3, according to an embodiment of the present disclosure, a program module 310 (e.g., the program 140) may include an OS controlling resources related to the electronic device (e.g., the electronic device 101) and/or various applications (e.g., the AP 147) driven on the OS. The OS may include, e.g., Android™, iOS™, Windows™, Symbian™, Tizen™, or Bada™. Referring to FIG. 3, the program module 310 may include a kernel 320 (e.g., the kernel 141), middleware 330 (e.g., the middleware 143), an API 360 (e.g., the API 145), and/or an application 370 (e.g., the application program 147). At least a part of the program module 310 may be preloaded on the electronic device or may be downloaded from an external electronic device (e.g., the electronic devices 102 and 104 or server 106).

The kernel 320 may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a BT driver, a shared memory driver, a USB driver, a keypad driver, a Wi-Fi driver, an audio driver, or an inter-process communication (IPC) driver. The middleware 330 may provide various functions to the application 370 through the API 360 so that the application 370 may use limited system resources in the electronic device or provide functions jointly required by applications 370. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or arithmetic function processing. The application manager 341 may manage the life cycle of, e.g., the applications 370. The window manager 342 may manage graphical user interface (GUI) resources used on the screen. The multimedia manager 343 may grasp formats necessary to play media files and use a codec appropriate for a format to perform encoding or decoding on media files. The resource manager 344 may manage the source code or memory space of the application 370. The power manager 345 may manage, e.g., the battery capability or power and provide power information necessary for the operation of the electronic device. According to an embodiment of the present disclosure, the power manager 345 may interwork with a basic input/output system (BIOS). The database manager 346 may generate, search, or vary a database to be used in the applications 370. The package manager 347 may manage installation or update of an application that is distributed in the form of a package file.

The connectivity manager 348 may manage, e.g., wireless connectivity. The notification manager 349 may provide an event, e.g., arrival message, appointment, or proximity alert, to the user. The location manager 350 may manage, e.g., locational information on the electronic device. The graphic manager 351 may manage, e.g., graphic effects to be offered to the user and their related user interface. The security manager 352 may provide system security or user authentication, for example. According to an embodiment of the present disclosure, the middleware 330 may include a telephony manager for managing the voice or video call function of the electronic device or a middleware module able to form a combination of the functions of the above-described elements. According to an embodiment of the present disclosure, the middleware 330 may provide a module specified according to the type of the OS. The middleware 330 may dynamically omit some existing components or add new components. The API 360 may be a set of, e.g., API programming functions and may have different configurations depending on OSs. For example, in the case of Android or iOS, one API set may be provided per platform, and in the case of Tizen, two or more API sets may be offered per platform.

The application 370 may include an application that may provide, e.g., a home 371, a dialer 372, a short message service (SMS)/multimedia messaging service (MMS) 373, an instant message (IM) 374, a browser 375, a camera 376, an alarm 377, a contact 378, a voice dial 379, an email 380, a calendar 381, a media player 382, an album 383, or a clock 384, a health-care (e.g., measuring the degree of workout or blood sugar), or provision of environmental information (e.g., provision of air pressure, moisture, or temperature information). According to an embodiment of the present disclosure, the application 370 may include an information exchanging application supporting information exchange between the electronic device and an external electronic device. Examples of the information exchange application may include, but is not limited to, a notification relay application for transferring specific information to the external electronic device, or a device management application for managing the external electronic device. For example, the notification relay application may transfer notification information generated by other application of the electronic device to the external electronic device or receive notification information from the external electronic device and provide the received notification information to the user. For example, the device management application may install, delete, or update a function (e.g., turn-on/turn-off the external electronic device (or some elements) or adjusting the brightness (or resolution) of the display) of the external electronic device communicating with the electronic device or an application operating on the external electronic device. According to an embodiment of the present disclosure, the application 370 may include an application (e.g., a health-care application of a mobile medical device) designated according to an attribute of the external electronic device. According to an embodiment of the present disclosure, the application 370 may include an application received from the external electronic device. At least a portion of the program module 310 may be implemented (e.g., executed) in software, firmware, hardware (e.g., the processor 210), or a combination of at least two or more thereof and may include a module, program, routine, command set, or process for performing one or more functions.

As used herein, the term “module” includes a unit configured in hardware, software, or firmware and may be interchangeably used with other term, e.g., a logic, logic block, part, or circuit. The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

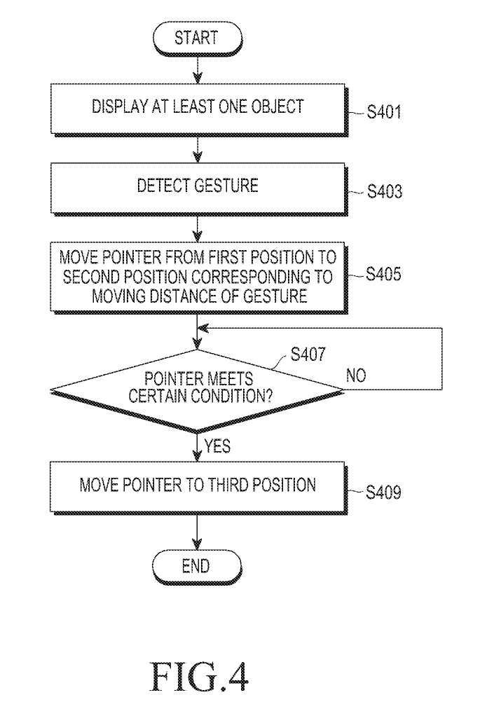

FIG. 4 is a flowchart illustrating a method for controlling an electronic device according to an embodiment of the present disclosure.

Referring to FIG. 4, according to an embodiment of the present disclosure, in operation S401, the display (e.g., the display 160) of the electronic device (e.g., the electronic device 101) may display at least one object.

According to an embodiment of the present disclosure, at least one object may be a menu, button, or icon.

According to an embodiment of the present disclosure, in operation S403, the sensor (e.g., the sensor module 240) may detect a gesture from the outside (e.g., the user).

According to an embodiment of the present disclosure, in operation S405, the processor (e.g., the processor 120) may display a pointer on the display 120 and move the pointer from a first position to a second position corresponding to the moving distance of the gesture.

According to an embodiment of the present disclosure, in operation S407, the processor 120 may determine whether the pointer meets a certain condition.

For example, the processor 120 may determine whether a moving state (e.g., position, speed, or acceleration) of the pointer moved to the second position corresponding to the moving distance of the gesture meets a certain condition (e.g., whether it is maintained for a certain time) and may leave the pointer at the second position or move to a third position based on the result of the determination.

According to an embodiment of the present disclosure, in operation S409, when the pointer meets the certain condition, the processor 120 may move the pointer from the second position to the third position.

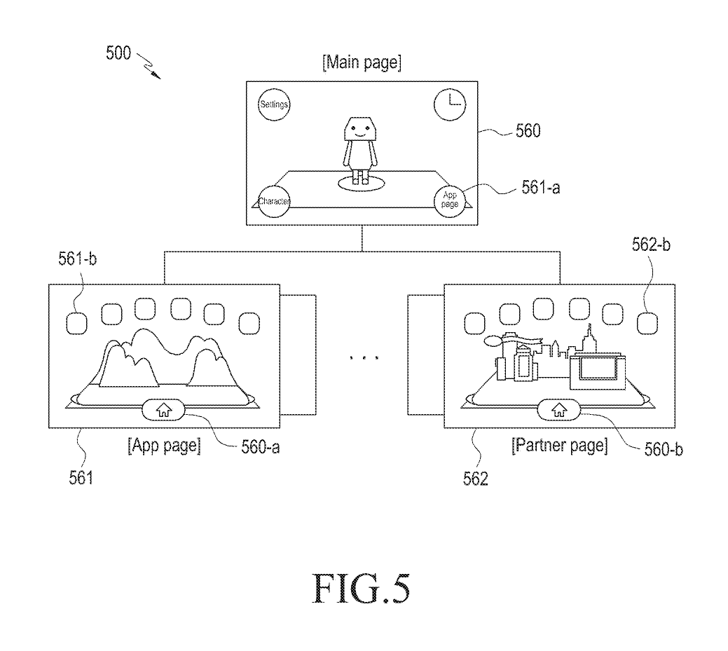

FIG. 5 illustrates a structure of a motion detection user experience (UX) screen according to an embodiment of the present disclosure.

Referring to FIG. 5, for example, a display 560 of an electronic device 500 may display a main page (e.g., [Main Page]), an application page (hereinafter, simply referred to as an app page) (e.g., [App Page]), and/or a partner page (e.g., [Partner Page]).

For example, the display 560 may display, on the main page, an app page object 561-a allowing for a switch to the app page. For example, when the user's input (e.g., a touch input) is received through an app page object 561, the processor 120 may display an app page 561 on the display 560.

For example, the display 560 may display, on the app page 561, at least one object 561-b allowing for a switch to a partner page 562. For example, the display 560 may display, on the app page 561, a main page object 560-a allowing for a switch to the main page object 560-b.

For example, the display 560 may display, on the partner page 562, an execution screen corresponding to one 561-b of at least one object of the app page 561. For example, the display 560 may display, on the partner page 562, at least one object 562-b allowing for a switch to another partner page.

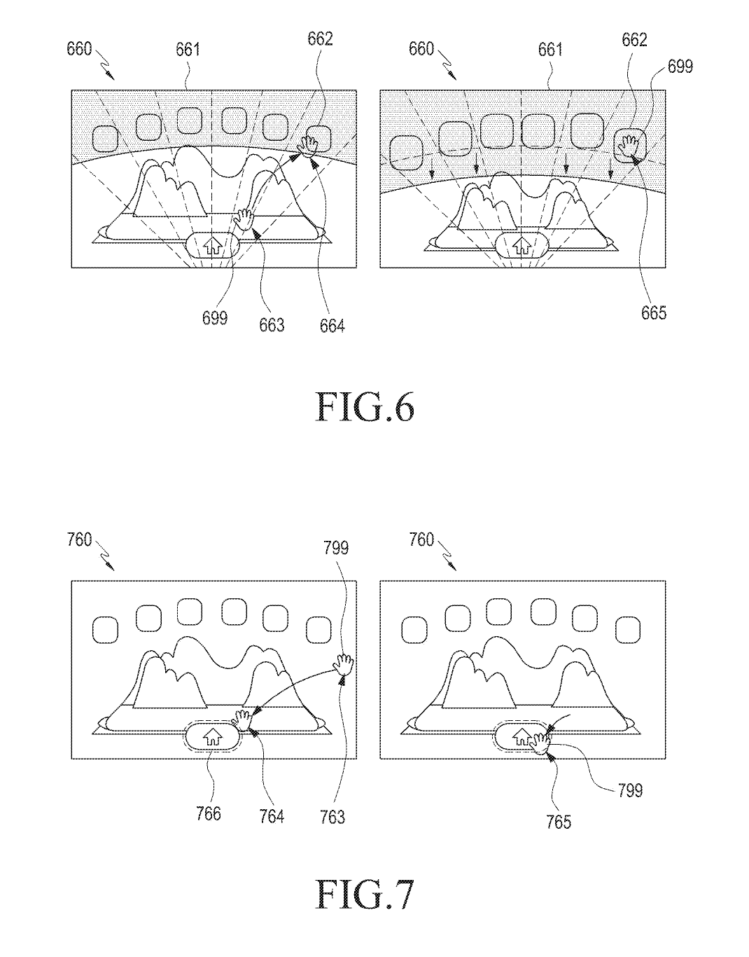

FIG. 6 illustrates an app page screen according to an embodiment of the present disclosure.

Referring to FIG. 6, for example, a display 660 may display a first object 662 of at least one object. For example, the display 660 may display a first area 661 including the first object 662 of the at least one object. For example, the display 660 may display a pointer 699.

According to an embodiment of the present disclosure, the processor (e.g., the processor 120) may move the pointer 699 from a first position 663 to a second position 664 corresponding to a gesture detected by the sensor (e.g., the sensor module 240).

For example, the sensor 240 may include a camera sensor, a remote controller sensor, or all types of sensors capable of detecting gestures.

According to an embodiment of the present disclosure, when the pointer moved to the second position 664 meets a certain condition, the processor 120 may magnify and display the first area 661 and move the pointer 699 from the second position 664 to a third position 665 corresponding to the first object 662 of the at least one object.

For example, the processor 120 may determine whether the second position 664 is a position corresponding to the first object 662, and when the second position 664 is the position corresponding to the first object 662, the processor 120 may determine that the pointer meets the certain condition.

FIG. 7 illustrates an app page screen according to an embodiment of the present disclosure.

Referring to FIG. 7, for example, the processor (e.g., the processor 120) may identify the user's hand corresponding to the gesture detected by the sensor (e.g., the sensor module 240).

For example, when a pointer 799 displayed at a first position 763 on a display 760 is moved to a second position 764 corresponding to a first object 766 according to the gesture corresponding to the user's right hand, the processor 120 may determine that the pointer 799 meets the certain condition and identify that the user's hand corresponding to the gesture is the user's right hand, and the processor 120 may move the pointer 799 to a third position 765 in the right area on the first object 766.

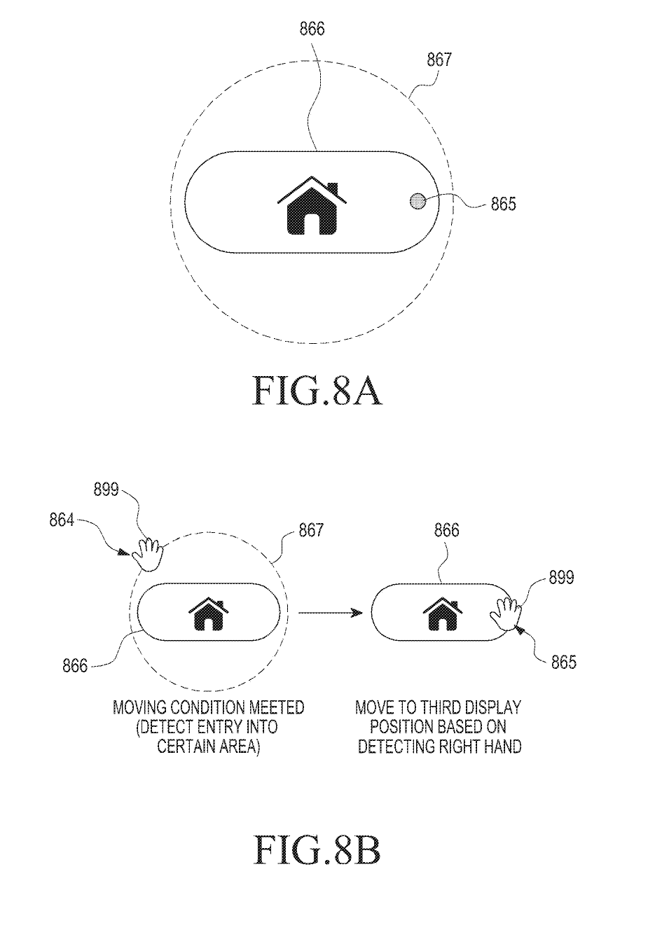

FIGS. 8A and 8B illustrate a first object according to an embodiment of the present disclosure.

Referring to FIG. 8A, according to an embodiment of the present disclosure, the display (e.g., the display 160) may display a first object 866.

For example, the processor (e.g., the processor 1200) may move the pointer according to a gesture detected by the sensor (e.g., the sensor module 240) and may determine whether the moved pointer 799 is positioned in a first area 867 that is within a certain distance from the center portion of the first object 866.

Referring to FIG. 8B, upon detecting that a pointer 899 enters into the first area 867 which is within the certain distance from the center portion of the first object 866, i.e., when a second position 864 of the pointer 899 is on the first area 867, the processor 120 may move the pointer 899 from the second position 864 to a third position on the first object 866.

For example, upon identifying that the user's hand corresponding to the gesture having moved the pointer 899 is the user's right hand, the processor 120 may move the pointer 899 from the second position 864 to a right-hand area (third position) 865 on the first object 866.

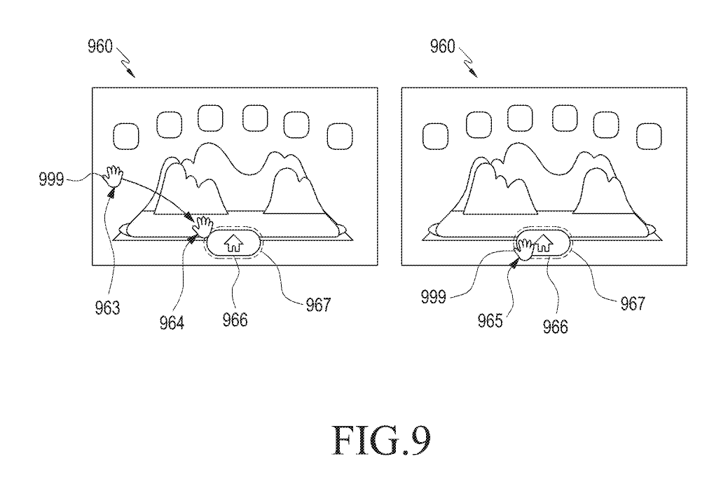

FIG. 9 illustrates an app page screen according to an embodiment of the present disclosure.

Referring to FIG. 9, for example, the processor (e.g., the processor 120) may identify the user's hand corresponding to the gesture detected by the sensor (e.g., the sensor module 240).

For example, when a pointer 999 displayed at a first position 963 on a display 960 is moved to a second position 964 corresponding to a first object 966 according to the gesture corresponding to the user's left hand, the processor 120 may determine that the pointer 999 meets the certain condition and identify that the user's hand corresponding to the gesture is the user's left hand, and the processor 120 may move the pointer 999 to the third position 965 in the left area 967 on the first object 966.

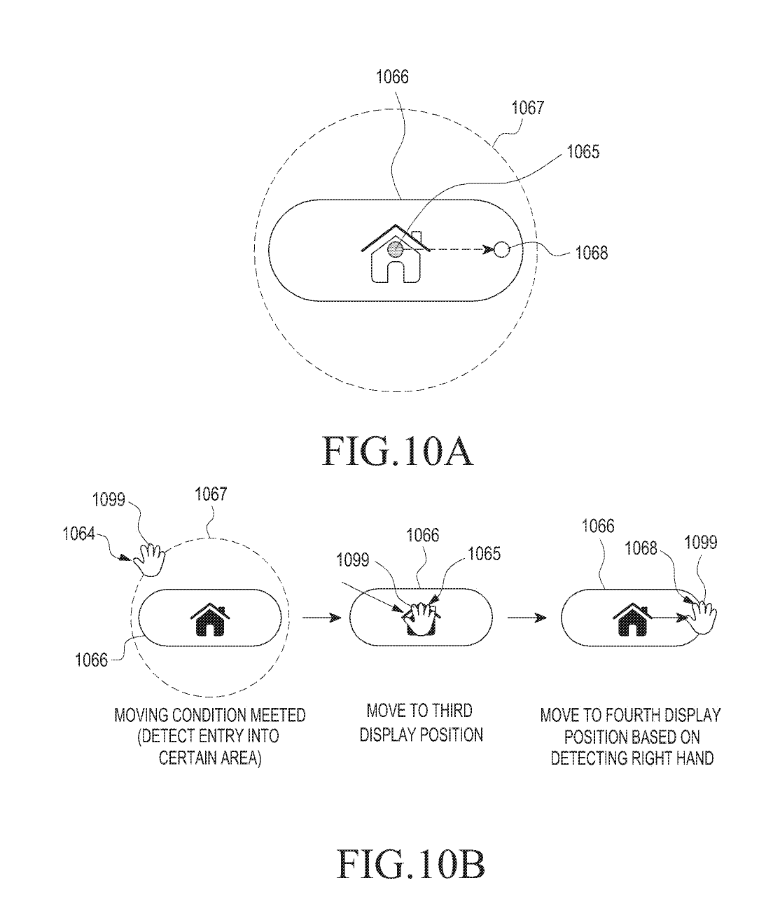

FIGS. 10A and 10B illustrate a method for moving a pointer according to an embodiment of the present disclosure.

Referring to FIGS. 10A and 10B, according to an embodiment of the present disclosure, the display (e.g., the display 160) may display a first object 1066. For example, the processor 120 may move the pointer (e.g., the pointer 999) from a first position to a second position on the display 160 according to a gesture detected by the sensor (e.g., the sensor module 240).

According to an embodiment of the present disclosure, when a second position 1064 is in a first area 1067 that is within a certain distance from the first object 1066, the processor 120 may move the pointer 1099 to a third position 1065 which is a center area on the first object 1066.

According to an embodiment of the present disclosure, the processor 120 may identify the user's hand corresponding to the gesture, and a certain time after moving the pointer 1099 to the third position 1065, the processor 120 may move the pointer 1099 from the third position 1065 to a right-hand area, a first position 1068, on the first object 1066 corresponding to identifying that the user's hand is his right hand

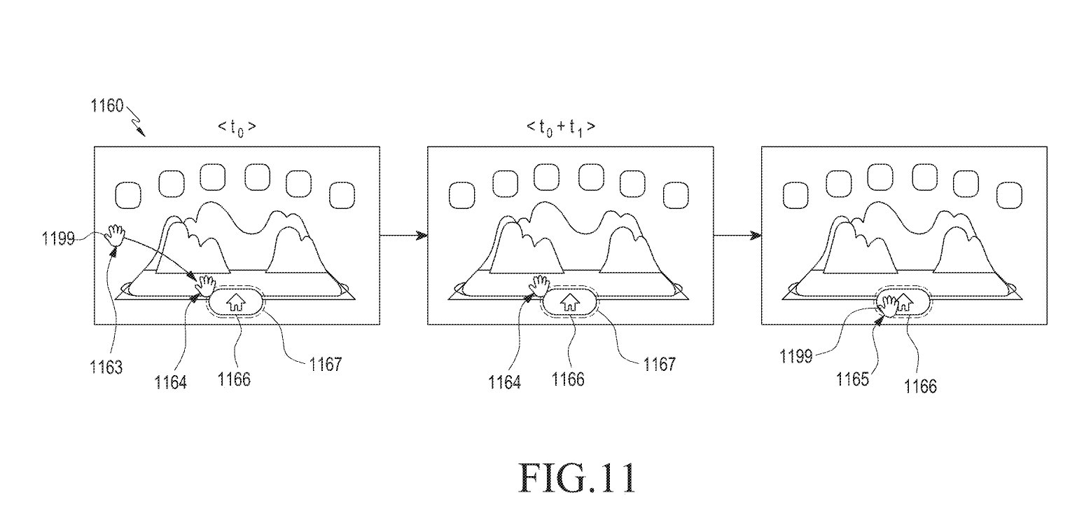

FIG. 11 illustrates an app page screen according to an embodiment of the present disclosure.

Referring to FIG. 11, according to an embodiment of the present disclosure, the processor (e.g., the processor 120) may move a pointer 1199 from a first position 1163 to a second position 1164 on a display 1160 at <t₀>, corresponding to a gesture detected by the sensor (e.g., the sensor module 240). For example, the processor 120 may determine whether the second position 1164 stays for a certain time <t₁> in a first area 1167 that is within a certain distance from a first object 1166. For example, when it is determined that the second position 1164 stays in the first area 1167 for the certain time <t₁>, the processor 120 may move the pointer 1199 from the second position 1164 to a third position 1165.

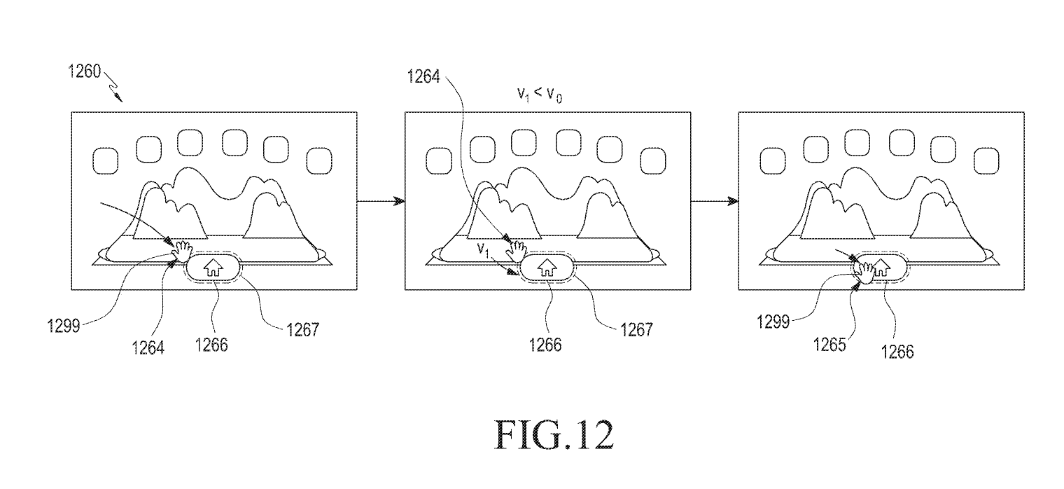

FIG. 12 illustrates an app page screen according to an embodiment of the present disclosure.

Referring to FIG. 12, according to an embodiment of the present disclosure, the processor (e.g., the processor 120) may move a pointer 1299 from a first position 1263 to a second position 1264 on a display 1260, corresponding to a gesture detected by the sensor (e.g., the sensor module 240).

For example, the processor 120 may determine whether the pointer at the second position 1264 moves at a lower speed than a certain speed <v₁> in a first area 1267 that is within a certain distance from a first object 1266. For example, when it is determined that the pointer at the second position 1264 moves at a speed lower than the certain speed <v₁> in the first area 1267, the processor 120 may move the pointer 1299 from the second position 1264 to a third position 1265.

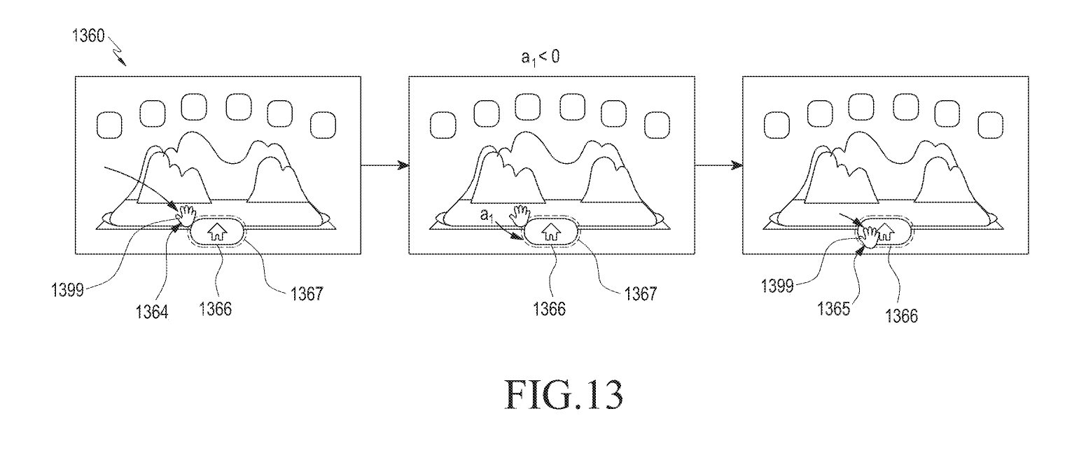

FIG. 13 illustrates an app page screen according to an embodiment of the present disclosure.

Referring to FIG. 13, according to an embodiment of the present disclosure, the processor (e.g., the processor 120) may move a pointer 1399 from a first position 1363 to a second position 1364 on a display 1360, corresponding to a gesture detected by the sensor (e.g., the sensor module 240). For example, the processor 120 may determine whether the pointer at a second position 1364 moves at a reducing speed (e.g., the acceleration ai of the pointer is smaller than 0) in a first area 1367 that is within a certain distance from a first object 1366. For example, when it is determined that the pointer at the second position 1364 moves at a reducing speed (e.g., the acceleration (a₁) of the pointer is smaller than 0) in the first area 1367, the processor 120 may move the pointer 1399 from the second position 1364 to a third position 1365.

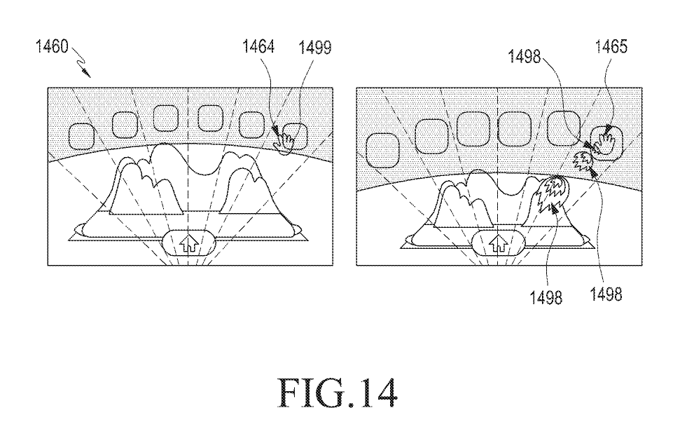

FIG. 14 illustrates an app page according to an embodiment of the present disclosure.

Referring to FIG. 14, according to an embodiment of the present disclosure, the processor (e.g., the processor 120) may move a pointer 1499 to a second position 1464 on a display 1460 and may determine whether a pointer 1499 meets a certain condition.

According to an embodiment of the present disclosure, when the pointer 1499 meets the certain condition, the processor 120 may move the pointer 1499 from the second position 1464 to a third position 1465 and may display at least one animation effect (e.g., a flame shape effect) 1498 on a moving route of the pointer 1499 on the display 1460.

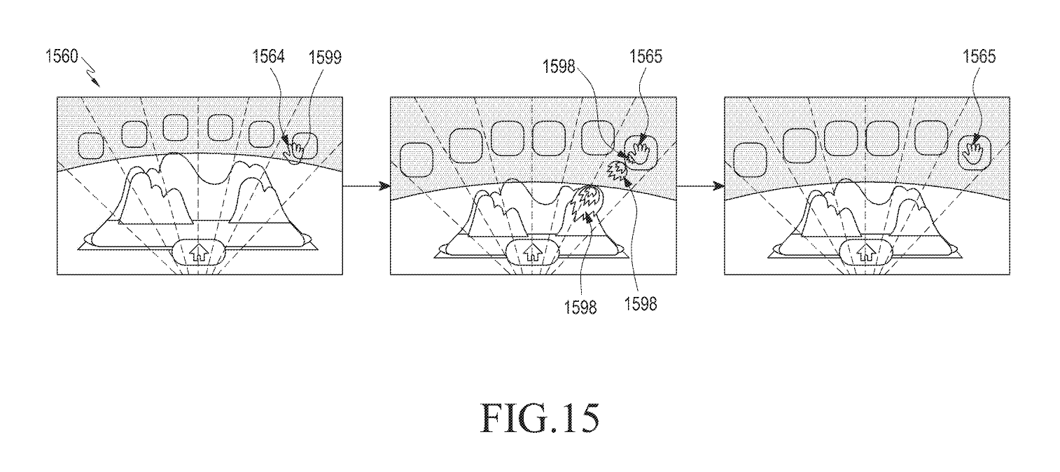

FIG. 15 illustrates an app page according to an embodiment of the present disclosure.

Referring to FIG. 15, according to an embodiment of the present disclosure, the processor (e.g., the processor 120) may move a pointer 1599 to a second position 1564 on a display 1560 and may determine whether the pointer 1599 meets a certain condition.

According to an embodiment of the present disclosure, when the pointer 1599 meets the certain condition, the processor 120 may move the pointer 1599 from the second position 1564 to a third position 1565 and may display at least one animation effect (e.g., a flame shape effect) 1598 on a moving route of the pointer 1599 on the display 1560, and after a certain time, remove the animation effect 1598 from the display.

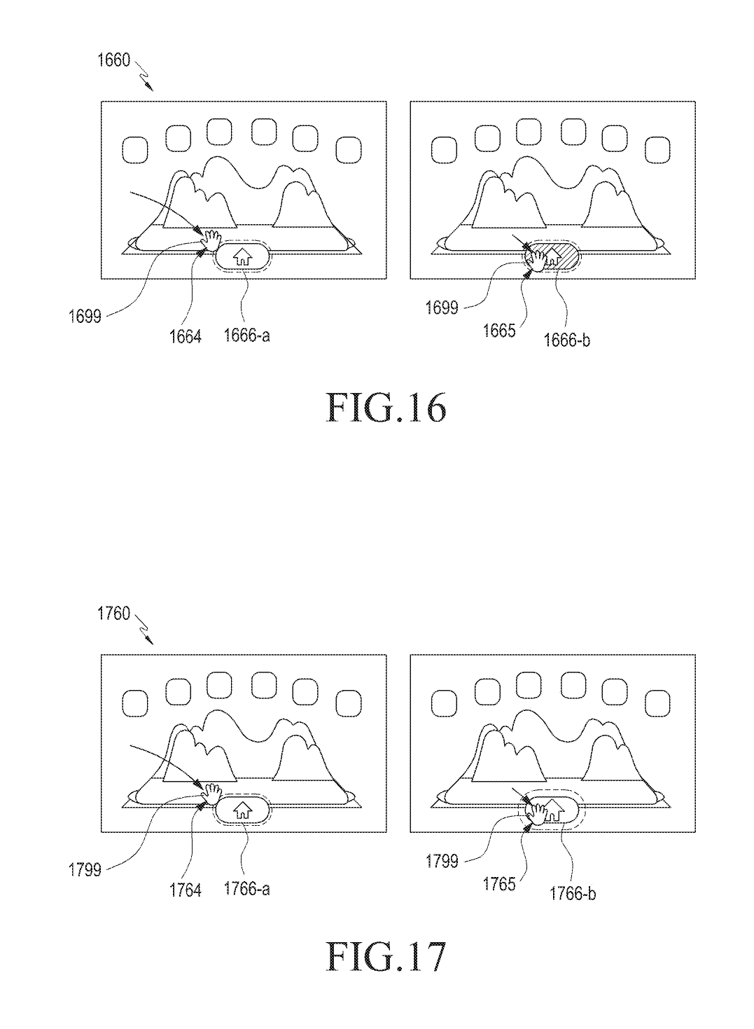

FIG. 16 illustrates an app page according to an embodiment of the present disclosure.

Referring to FIG. 16, according to an embodiment of the present disclosure, the processor (e.g., the processor 120) may move a pointer 1699 to a second position 1664 on a display 1660 and may determine whether the pointer 1699 meets a certain condition.

According to an embodiment of the present disclosure, when the pointer 1699 meets the certain condition, the processor 120 may move the pointer 1699 from the second position 1664 to a third position 1665 and may change the color of a first object 1666-a to a color of a second object 1666-b corresponding to the third position 1665.

FIG. 17 illustrates an app page according to an embodiment of the present disclosure.

Referring to FIG. 17, according to an embodiment of the present disclosure, the processor (e.g., the processor 120) may move a pointer 1799 to a second position 1764 on a display 1760 and may determine whether the pointer 1799 meets a certain condition.

According to an embodiment of the present disclosure, when the pointer 1799 meets the certain condition, the processor 120 may move the pointer 1799 from the second position 1764 to a third position 1765 and may change the size of a first object 1766-a to a color of a second object 1766-b corresponding to the third position 1765.

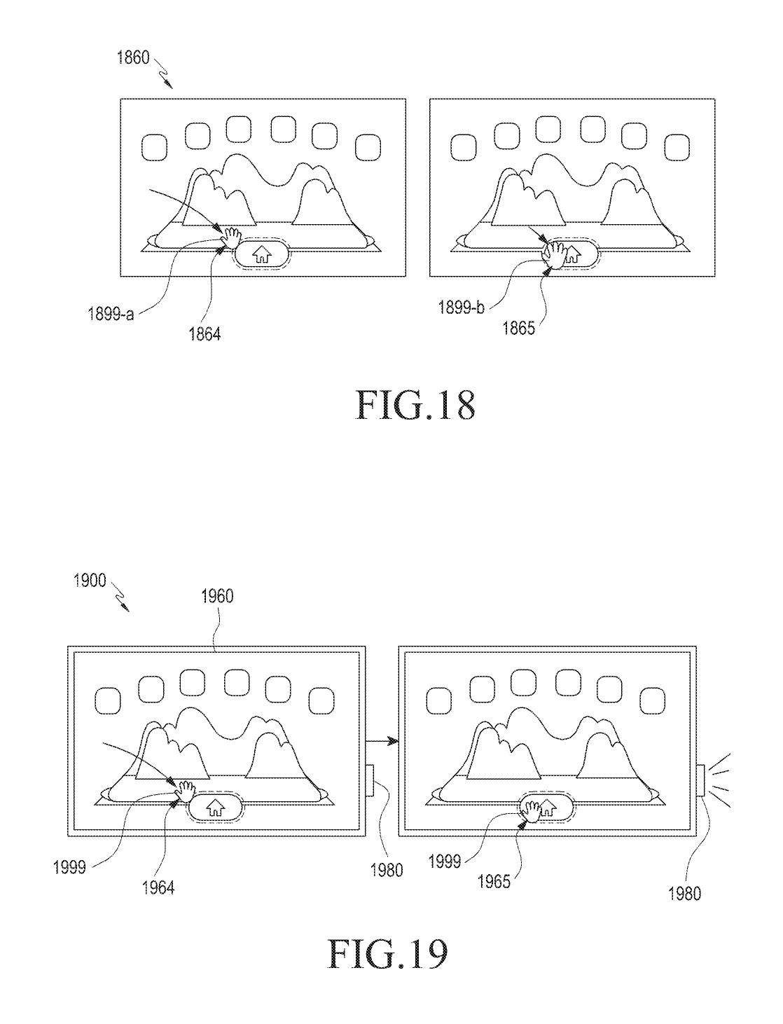

FIG. 18 illustrates an app page according to an embodiment of the present disclosure.

Referring to FIG. 18, according to an embodiment of the present disclosure, the processor (e.g., the processor 120) may move a pointer 1899-a to a second position 1864 on a display 1860 and may determine whether the pointer 1899-a meets a certain condition.

According to an embodiment of the present disclosure, when the pointer 1899-a meets the certain condition, the processor 120 may move the pointer 1899-a from the second position 1864 to a third position 1865 and may magnify and display the pointer 1899-b moved to the third position 1865.

FIG. 19 illustrates an app page according to an embodiment of the present disclosure.

Referring to FIG. 19, according to an embodiment of the present disclosure, the processor (e.g., the processor 120) may move a pointer 1999 to a second position 1964 on a display 1960 and may determine whether the pointer 1999 meets a certain condition.

For example, an electronic device 1900 may include a speaker 1980 capable of outputting sounds.

According to an embodiment of the present disclosure, when the pointer 1999 meets the certain condition, the processor 120 may move the pointer 1999 from the second position 1964 to a third position 1965 and may output a sound effect corresponding to the movement of the pointer 1999 through the speaker 1980.

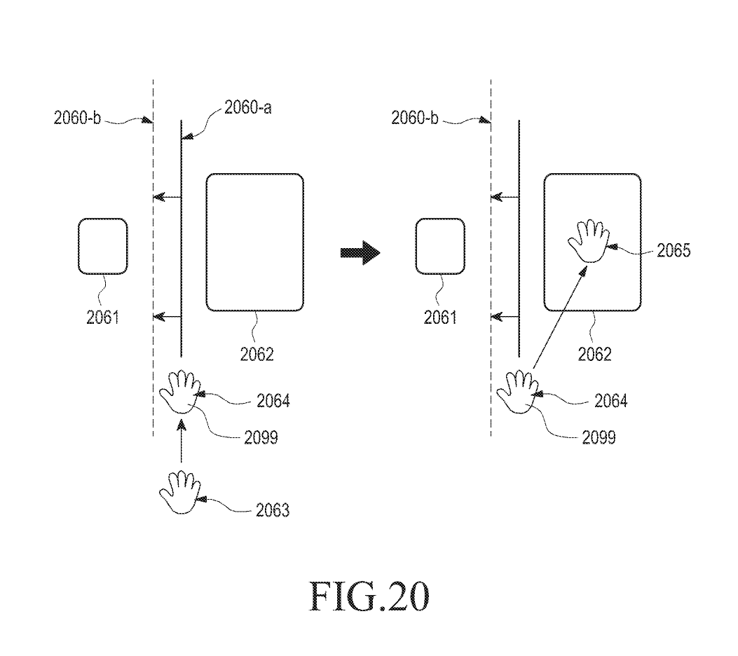

FIG. 20 illustrates a first object and a second object according to an embodiment of the present disclosure.

Referring to FIG. 20, according to an embodiment of the present disclosure, the processor (e.g., the processor 120) may determine an area corresponding to one of a first object 2061 and a second object 2062 displayed on the display (e.g., the display 160) where a pointer 2099 is positioned 2063.

For example, the processor 120 may determine the area corresponding to the object where the pointer 2099 is positioned based on the size of the first object 2061 and the second object 2062. For example, when it is determined that the pointer 2099 is positioned over a first reference line 2060-a which is a middle point between the first object 2061 and the second object 2062 and is positioned in a right-hand area (an area at the side of the second object 2062) of a second reference line 2060-b determined based on the size of the first object 2061 and the second object 2062 as shown in FIG. 20, the processor 120 may move the pointer 2099 from position 2064 to a third position 2065 that is an area corresponding to the second object 2062.

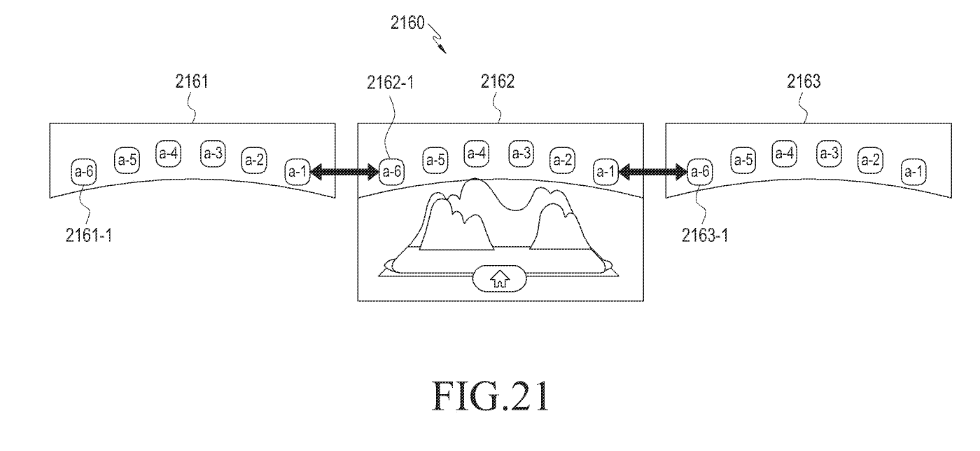

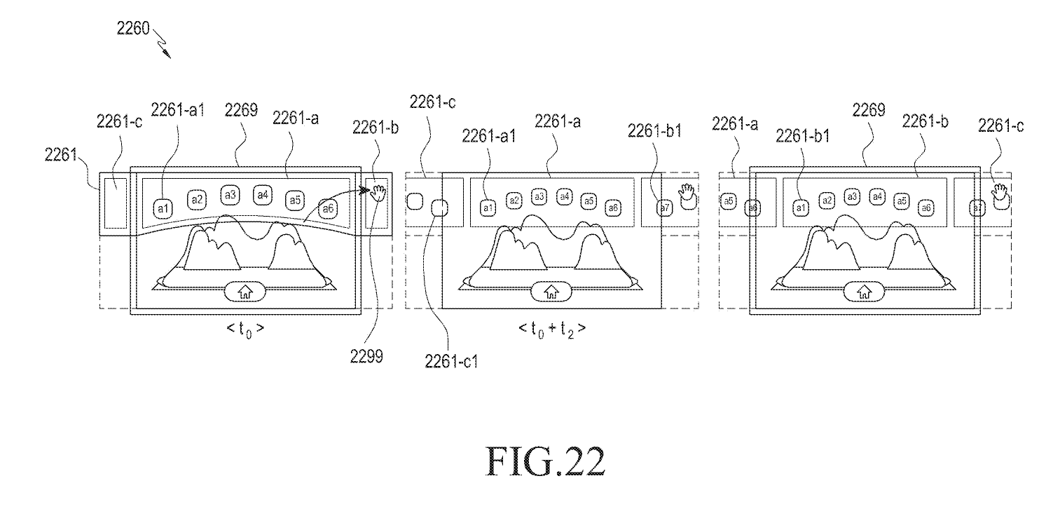

FIGS. 21 and 22 illustrate app pages according to various embodiments of the present disclosure.

Referring to FIG. 21, according to an embodiment of the present disclosure, a display 2160 may display a first object group 2161 including at least one first object 2161-1 on a display area of the display 2160, a second object group 2162 including at least one second object 2162-1 on a display area of the display 2160, and a third object group 2163 including at least one third object 2163-1 on a display area of the display 2160.

For example, the processor 120 may determine whether the pointer is moved onto a non-display area 2261 and 2262 other than the display area of the display 2160 corresponding to a gesture detected by the sensor (e.g., the sensor module 240).

Referring to FIG. 22, a first object group 2261-a including a first object 2261-a1, a second object group 2261-b including a second object 2261-b1, and a third object group 2261-c including a third object 2261-c1 are illustrated. According to an embodiment of the present disclosure, upon determining that a pointer 2299 is moved to a non-display area other than a display area 2269 on a display 2260 at <t₀>, the processor 120 may determine whether the pointer 2299 stays in the non-display area for a certain time (e.g., <t₂>).

For example, upon determining that the pointer 2299 is positioned in the non-display area for the certain time (e.g., <t₂>), the processor 120 may display, on the display area 2269 of the display 2260), the second object group 2261-b including the second object 2261-b1 included in the non-display area on the display 2260 where the pointer 2299 is positioned and move the first object group 2261-a used to be displayed on the display area 2269 to the non-display area.

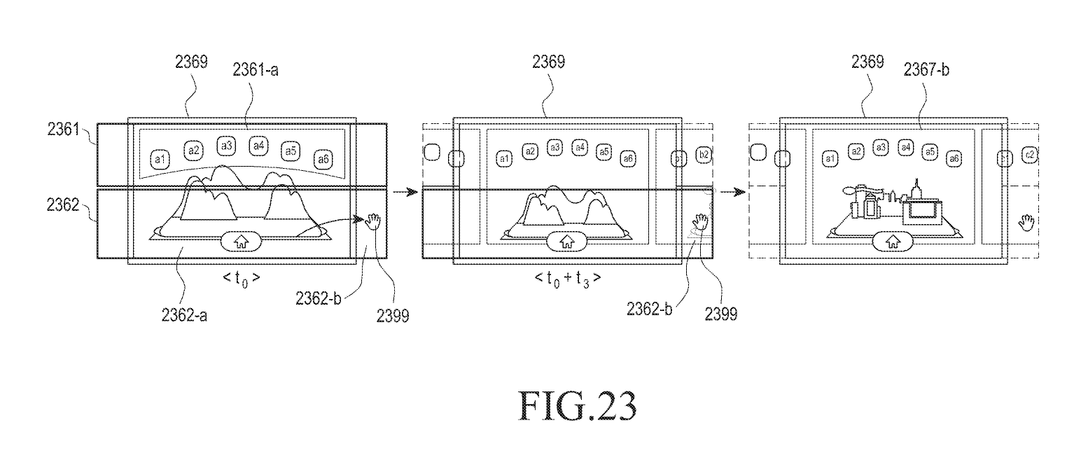

FIG. 23 illustrates an app page according to an embodiment of the present disclosure.

Referring to FIG. 23, the processor (e.g., the processor 120) may display at least one object including a first object 2361-a on a first area 2361 of a display area 2369 of the display and may display an execution screen 2362-a corresponding to the first object 2361-a on a second area 2362 of the display area 2369.

According to an embodiment of the present disclosure, the processor (e.g., the processor 120) may move the pointer 2399 at <t₀> from the display area 2369 to the non-display area 2362-b corresponding to a gesture detected by the sensor (e.g., the sensor module 240).

According to an embodiment of the present disclosure, the processor 120 may determine whether the pointer 2399 is positioned on the non-display area 2362-b for a certain time (e.g., <t₃>).

According to an embodiment of the present disclosure, when the pointer 2399 is positioned on the non-display area 2362-b from the certain time (e.g., <t₃>), the processor 120 may display another execution screen 2367-b corresponding to the non-display area 2362-b on the display area 2369.

According to an embodiment of the present disclosure, an electronic device may include a display configured to display at least one object, a sensor configured to detect a gesture, and a processor configured to move a pointer from a first position to a second position on the display, corresponding to a moving distance of the gesture, and when the pointer meets a certain condition, move the pointer to a third position on the display.

According to an embodiment of the present disclosure, the third position may include a position on a first object of the at least one object.

According to an embodiment of the present disclosure, the second position may include a first area that is within a certain distance from a first object of the at least one object.

According to an embodiment of the present disclosure, the processor may move the pointer to the third position when the pointer is positioned on the first area for a certain time.

According to an embodiment of the present disclosure, the processor may move the pointer to the third position when a speed of the pointer moving on the first area is not larger than a certain speed.

According to an embodiment of the present disclosure, the processor may move the pointer to the third position when a speed of the pointer moving on the first area decreases.

According to an embodiment of the present disclosure, the processor may move the pointer to the third position when the speed of the pointer moving on the first area is not larger than the certain speed or keeps decreasing for a certain time.

According to an embodiment of the present disclosure, the processor may determine whether the pointer meets the certain condition based on the size of the first object and the size of at least another object.

According to an embodiment of the present disclosure, the processor may display an animation effect corresponding to the movement of the pointer.

According to an embodiment of the present disclosure, the processor may change the size or color of the first object.

According to an embodiment of the present disclosure, the processor may change any one or more of the size, color, or moving route of the pointer.

According to an embodiment of the present disclosure, the electronic device may further include a speaker, and the processor may output a sound effect corresponding to the movement of the pointer through the speaker.

According to an embodiment of the present disclosure, the processor may remove the displayed animation effect after the pointer moves to the third position.

According to an embodiment of the present disclosure, the processor may move the pointer to a fourth position on the first object a certain time after the pointer is moved to the third position.

According to an embodiment of the present disclosure, the processor may identify a user's hand corresponding to the gesture and determine the fourth position based on the user's hand

According to an embodiment of the present disclosure, the display may display a second area including the at least one object, and the processor may magnify the second area when the pointer moves to the second area.

According to an embodiment of the present disclosure, a method for controlling an electronic device may include displaying at least one object, detecting a gesture, moving a pointer from a first position to a second position corresponding to a moving distance of the gesture, and moving the pointer to a third position when the pointer meets a certain condition.

According to an embodiment of the present disclosure, an electronic device may include a display configured to display at least one object on a display area, a sensor configured to detect a gesture, and a processor moving a pointer corresponding to a moving distance of the gesture and displaying at least another object related to the at least one object on the display area when the pointer is moved to a non-display area of the display.

According to an embodiment of the present disclosure, the display area may include a first area displaying the at least one object and a second area displaying an execution screen corresponding to the at least one object, and the processor may display a preview screen corresponding to the first object on the second area when the pointer is moved to a position corresponding to a first object of the at least another object.

According to an embodiment of the present disclosure, the processor may display an execution screen corresponding to the first object on the second area when the pointer stays at the position corresponding to the first object for a certain time.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display configured to display at least one object;
a sensor configured to detect a gesture; and
a processor configured to:
move a pointer from a first position to a second position on the display, corresponding to a moving distance of the gesture, and
move, when the pointer meets a certain condition, the pointer to a third position on the display.

2. The electronic device of claim 1, wherein the third position comprises a position on a first object of the at least one object.

3. The electronic device of claim 1, wherein the second position comprises a first area that is within a certain distance from a first object of the at least one object.

4. The electronic device of claim 3, wherein the processor is further configured to move the pointer to the third position when the pointer is positioned on the first area for a certain time.

5. The electronic device of claim 3, wherein the processor is further configured to move the pointer to the third position when a speed of the pointer moving on the first area is not larger than a certain speed.

6. The electronic device of claim 3, wherein the processor is further configured to move the pointer to the third position when a speed of the pointer moving on the first area decreases.

7. The electronic device of claim 5, wherein the processor is further configured to move the pointer to the third position when the speed of the pointer moving on the first area is not larger than the certain speed or keeps decreasing for a certain time.

8. The electronic device of claim 3, wherein the processor is further configured to determine whether the pointer meets the certain condition based on the size of the first object and the size of at least another object.

9. The electronic device of claim 1, wherein the processor is further configured to display an animation effect corresponding to the movement of the pointer.

10. The electronic device of claim 2, wherein the processor is further configured to change a size or color of the first object.

11. The electronic device of claim 1, wherein the processor is further configured to change any one or more of a size, color, or moving route of the pointer.

12. The electronic device of claim 1, further comprising a speaker, wherein the processor is further configured to output a sound effect through the speaker corresponding to the movement of the pointer.

13. The electronic device of claim 9, wherein the processor is further configured to remove the displayed animation effect after the pointer moves to the third position.

14. The electronic device of claim 2, wherein the processor is further configured to move the pointer to a fourth position on the first object at a certain time after the pointer is moved to the third position.

15. The electronic device of claim 14, wherein the processor is further configured to:
identify a user's hand corresponding to the gesture, and
determine the fourth position based on the user's hand

16. The electronic device of claim 1,
wherein the display is further configured to display a second area including the at least one object, and
wherein the processor is further configured to magnify the second area when the pointer moves to the second area.

17. A method for controlling an electronic device, the method comprising:
displaying at least one object;
detecting a gesture;
moving a pointer from a first position to a second position corresponding to a moving distance of the gesture; and
moving the pointer to a third position when the pointer meets a certain condition.

18. An electronic device comprising:
a display configured to display at least one object on a display area;
a sensor configured to detect a gesture; and
a processor configured to:
move a pointer corresponding to a moving distance of the gesture, and
display at least another object related to the at least one object on the display area when the pointer is moved to a non-display area of the display.

19. The electronic device of claim 18,
wherein the display area comprises a first area displaying the at least one object and a second area displaying an execution screen corresponding to the at least one object, and
wherein the processor is further configured to display a preview screen corresponding to the first object on the second area when the pointer is moved to a position corresponding to a first object of the at least another object.

20. The electronic device of claim 19, wherein the processor is further configured to display an execution screen corresponding to the first object on the second area when the pointer stays at the position corresponding to the first object for a certain time.
